(19) United States
(12) Patent Application Publication
(10) Pub. No.: US 2014/0254136 A1
(43) Pub. Date: Sep. 11, 2014

(54) LED SHELF LIGHT FOR PRODUCT DISPLAY CASES

(71) Applicant: Nthdegree Technologies Worldwide Inc., Tempe, AZ (US)

(72) Inventors: Bradley Steven Oraw, Chandler, AZ (US); Marc Oliver Meier, Chandler, AZ (US)

(73) Assignee: Nthdegree Technologies Worldwide Inc., Tempe, AZ (US)

(21) Appl. No.: 14/183,115

(22) Filed: Feb. 18, 2014

Related U.S. Application Data
(60) Provisional application No. 61/774,501, filed on Mar. 7, 2013.

(51) Int. Cl. F21V 19/00; F25D 27/00

(52) U.S. Cl. CPC F21V 19/004; F25D 27/00
USPC 362/92; 362/382

(57) ABSTRACT

A thin flexible light strip is formed by printing microscopic LEDs in rectangular sections along the light strip, where each rectangular section creates a vertically elongated emission profile. The light strip has a length approximately equal to the length of a shelf supporting products (e.g., bottles) to be illuminated. The shelf may be in a glass-door cooler in a store. Each section is located along the light strip to be centered with a product in the front row on the shelf. The light strip is supported by a plastic holder that attaches to the front of the shelf. The holder angles the light strip upward between 20-40 degrees, relative to vertical, to substantially uniformly illuminate each product equally. The holder may support an additional light strip that is angled downward toward products on a lower shelf.

### CROSS-REFERENCE TO RELATED APPLICATIONS

This application is based on U.S. provisional application Ser. No. 61/774,501, filed Mar. 7, 2013, by Bradley Steven Oraw et al., assigned to the present assignee and incorporated herein by reference.

### FIELD OF THE INVENTION

This invention relates to forming an elongated shelf light for illuminating the fronts of products, such as for illuminating a row of bottles in a display cooler in a store, where the light is formed using a layer of light emitting diodes (LEDs).

### BACKGROUND

Large glass-door coolers in a store, such as for displaying bottles, are typically provided with vertically oriented lighting, such as an upright fluorescent bulb, along the front edge of both walls of the cooler. This side projection results in a transverse decrease in intensity for products far from the side and hot spots for products near to the side. This illumination non-uniformity is undesirable. Further, to provide adequate illumination of the products farthest from the light source, the flux required from the light source must be high. Such high brightness of the light source produces glare, and the light is inefficiently used. Additionally, a majority of the space in the cooler is not taken up by the products, such as the space above and below the products, and lighting of such empty space adds to the inefficiency. Still further, fluorescent bulbs become less bright and yellowish over time and must be replaced regularly.

What is needed is a more pleasing, efficient, and reliable lighting system for products in a glass-door display case, such as a cooler in a store displaying bottles.

### SUMMARY

Rather than remotely lighting the products in a glass-door display case, such as a cooler, an upward-angled strip of LEDs is secured to the front of the shelf supporting the products, such as bottles. If the position of each of the products in the front row is predetermined, the LEDs are grouped in rectangular sections along the light strip, where each section is centered with respect to a single product, so that the light is directed at the front of each product in the front row. The rectangular sections create a vertically elongated emission profile to more uniformly illuminate the product along its height.

The thin strip of LEDs is supported by a plastic holder that clips to the front lip of the shelf. Each strip has a pair of leads that connects to an edge connector for providing power to the strip.

In one embodiment, the strip is angled upward toward each product at approximately a 30 degree angle relative to the vertical. In another embodiment, two strips are supported by a single plastic holder attached to a shelf, where a top strip is angled upward toward the products on the shelf, and a bottom strip, hanging below the shelf, is angled downward toward the products below the shelf. Therefore, for all shelves except the top and bottom shelves, the products are illuminated from above and below for more uniform illumination.

The strip may be formed by selectively printing thousands of microscopic LEDs on a thin flexible substrate. The substrate has a conductive reflective surface. The LEDs are vertical LEDs (VLEDs), having a top electrode and a bottom electrode. Light exits through the LED surface supporting the top electrode. The top electrodes, facing the products, are contacted by a transparent conductor layer that connects the microscopic VLEDs in parallel. Two narrow metal runners extend horizontally along the strip and connect to the transparent conductor layer and the bottom conductor layer. The metal strips terminate in a 2-lead connector at one edge of the strip for connection to a power supply bus.

Other embodiments are disclosed.

### BRIEF DESCRIPTION OF THE DRAWINGS

FIG. 1 is a simplified cross-section of a monolayer of printed, microscopic vertical LEDs emitting light through a phosphor layer.

FIG. 2 is a simplified top down view of the structure of FIG. 1, where FIG. 1 is taken across a horizontally bisected FIG. 2. In actuality, the LEDs in each of the eight rectangular sections are randomly printed and may exceed several hundred LEDs per section.

FIG. 3 illustrates the completed light strip being inserted into a transparent plastic holder that clips onto a shelf of a glass-door cooler. Each section of LEDs aligns with the standardized location of a product (e.g., a bottle) on the shelf.

FIG. 4 is a perspective view of the completed lamp comprising the light strip in the plastic holder, where the holder has a bottom clip for clipping on the front of the shelf.

FIG. 5 is a side view of the shelf and the lamp clipped to the shelf.

FIG. 6 illustrates an end portion of the light emitting side of the lamp, where an end clip provides additional mechanical support at each end of the lamp. The end clip may also cover the electrical connector.

FIG. 7 illustrates the reverse side of the lamp showing the front of the end clip.

FIG. 8 illustrates two shelves in a glass-door cooler, where the lamps illuminate the fronts of bottles.

FIG. 9 is a close-up view of an end of the lamp being electrically connected to a power bus track along one wall of the cooler.

FIG. 10 is a cross-sectional view of a plastic holder for two light strips, where the top light strip is angled upward to illuminate the products on the shelf, and the bottom light strip is angled downward to illuminate the products below the shelf.

FIG. 11 is a perspective view of the plastic holder of FIG. 10 supporting the two light strips.

FIG. 12 illustrates how additional LEDs, either printed on the opposite side of the light strip of FIG. 3 or on a separate display strip, can form an alphanumeric display.

Elements that are similar or identical in the various figures are labeled with the same numeral.

### DETAILED DESCRIPTION

The GaN-based micro-LEDs used in embodiments of the present invention are less than a third the diameter of a human hair and less than a tenth as high, rendering them essentially invisible to the naked eye when the LEDs are sparsely spread across a substrate. The number of micro-LED devices per unit area may be freely adjusted when applying the micro-LEDs to the substrate. A well dispersed random distribution across the surface can produce nearly any desirable surface brightness. Lamps well in excess of 10,000 cd/m² have been demonstrated by the assignee. The LEDs may be printed as an ink using screen printing or other forms of printing. Further detail of forming a light source by printing microscopic vertical LEDs, and controlling their orientation on a substrate, can be found in US application publication US 2012/0164796, entitled, Method of Manufacturing a Printable Composition of Liquid or Gel Suspension of Diodes, assigned to the present assignee and incorporated herein by reference.

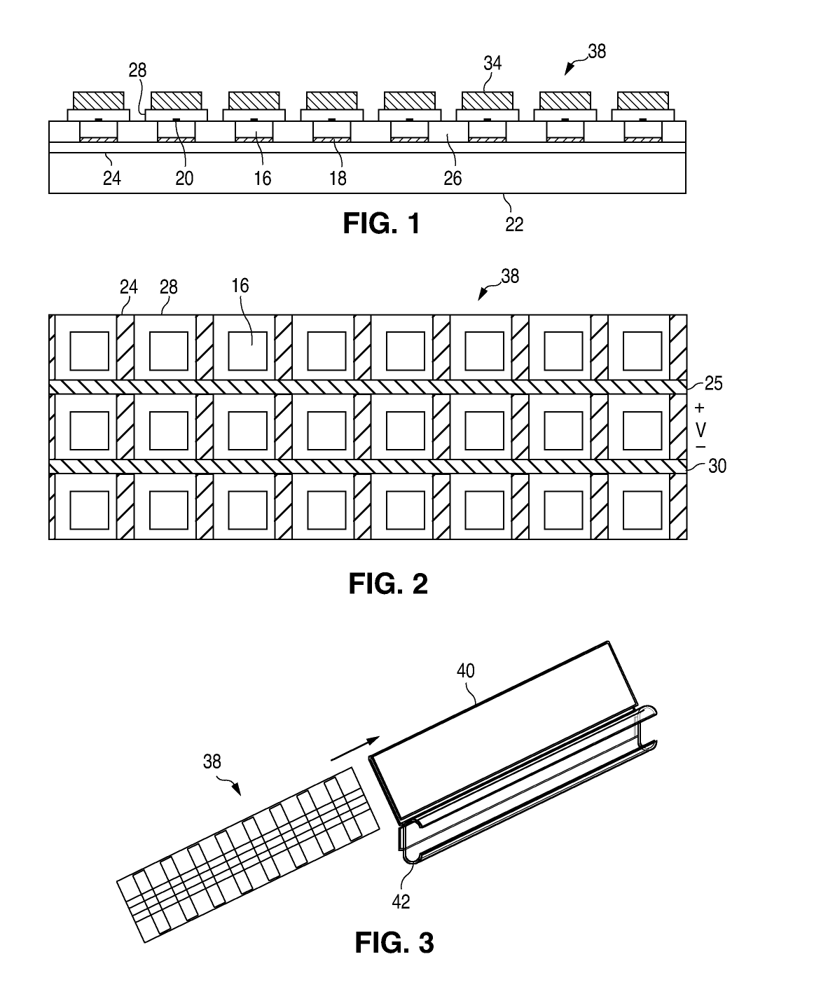

FIG. 1 is a cross-sectional view of a layer of vertical LEDs 16 (VLEDs) that may be used in the invention. Each LED 16 includes standard semiconductor GaN layers, including an n-layer, and active layer, and a p-layer.

In one embodiment, an LED wafer, containing many thousands of vertical LEDs, is fabricated so that the bottom metal cathode electrode 18 for each LED 16 includes a reflective layer (a mirror). The reflective layer should have a reflectivity of over 90% for visible light. The top metal anode electrode 20 for each LED 16, also reflective, is small to allow almost all the LED light to escape the anode side. There is some side light, depending on the thickness of the LED. The anode and cathode surfaces may be opposite to those shown.

The LEDs are completely formed on the wafer, including the anode and cathode metallizations, by using one or more carrier wafers during the processing and removing the growth substrate to gain access to both LED surfaces for metallization. The semiconductor surfaces of the LEDs may be roughened by etching to increase light extraction (i.e., decrease internal reflections). After the LEDs are formed on the wafer, trenches are photolithographically defined and etched in the front surface of the wafer around each LED, to a depth equal to the bottom electrode, so that each LED has a diameter less than 50 microns and a thickness of about 4-8 microns. A preferred shape of each LED is hexagonal. The trench etch exposes the underlying wafer bonding adhesive. The bonding adhesive is then dissolved in a solution to release the LEDs from the carrier wafer. Singulation may instead be performed by thinning the back surface of the wafer until the LEDs are singulated. The LEDs 16 of FIG. 1 result, depending on the metallization designs. The microscopic LEDs are then uniformly infused in a solvent, including a viscosity-modifying polymer resin, to form an LED ink for printing, such as screen printing, or flexographic printing.

The LEDs may instead be formed using many other techniques and may be much larger or smaller. The LED layers described herein may be constructed by techniques other than printing.

If it is desired for the anode electrodes 20 to be oriented in a direction opposite to the substrate 22 after printing, the electrodes 20 are made tall so that the LEDs 16 are rotated in the solvent, by fluid pressure, as they settle on the substrate surface. The LEDs 16 rotate to an orientation of least resistance. Over 90% like orientation has been achieved, although satisfactory performance may be achieved with over 75% of the LEDs being in the same orientation.

A starting substrate 22 is provided. The substrate 22 is preferably thin for light weight, low cost, and ease of processing. The substrate 22 may be a suitable polymer, such as polycarbonate, PMMA, or PET, and may be dispensed from a roll for roll-to-roll processing of the light strips. The substrate 22 (after singulation) may have dimensions of, for example, 1-2 inches by 24 inches for a particular shelf size.

If the substrate 22 itself is not conductive, a reflective conductor layer 24 (e.g., aluminum) is deposited on the substrate 22 such as by printing. If the conductor layer 24 is very thin and presents a relatively high resistance between its far ends, a highly conductive metal runner 25 (FIG. 2) may be printed along the length of the strip. In another embodiment, conductive vias may be formed through the substrate 22 that connect highly conductive metal runners formed on the bottom surface of the substrate 22 to conductive layers formed over the top of the substrate 22.

The LEDs 16 are then printed on the conductor layer 24 such as by screen printing with a suitable mesh to allow the LEDs to pass through and control the thickness of the layer. The mesh includes a mask to cause printing of the LEDs 16 in separated rectangular sections along the substrate 22 that align with standardized positions of the products to be illuminated. In the example, there are eight sections of LEDs 16 for illuminating eight bottles along the front row of a shelf in a cooler. Because of the relatively low concentration of LEDs, the LEDs 16 will be printed as a monolayer and be fairly uniformly distributed over the conductor layer 24 in each of the eight sections. Any other suitable deposition process may be used.

The solvent is then evaporated by heat using, for example, an infrared oven. After curing, the LEDs 16 remain attached to the underlying conductor layer 24 with a small amount of residual resin that was dissolved in the LED ink as a viscosity modifier. The adhesive properties of the resin and the decrease in volume of resin underneath the LEDs 16 during curing press the bottom LED electrode 18 against the underlying conductor 24, making ohmic contact with it.

In another embodiment, the conductor layer 24 is only formed within the eight sections to conserve materials, and the conductor layer sections are interconnected by the metal runner 25 (FIG. 2).

A transparent dielectric layer 26 is then selectively printed over the surface to encapsulate the LEDs 16 and further secure them in position. The ink used in the dielectric layer 26 may be designed to pull back from the upper surface of the LEDs 16 during curing to expose the top anode electrodes 20, so etching the dielectric layer 26 is not required. If the dielectric covers the electrodes 20, then a blanket etch may be used to expose the electrodes 20.

A top transparent conductor layer 28 is then printed over the dielectric layer 26 to electrically contact the electrodes 20 and cured in an oven appropriate for the type of transparent conductor being used. In FIG. 2, the transparent conductor layer 28 is shown only printed in the eight sections; however, the transparent conductor layer 28 may be printed substantially over the entire surface of the substrate 22.

As shown in the top down view of FIG. 2, a metal runner 30 is then screen printed to contact the transparent conductor layer 28 to form a low resistance path across the strip. The metal runner 25 over the conductor layer 24 is also shown since the LED layer is transparent. If the metal ink is solvent based, it may be cured in an oven. If it is a radiation cured silver, it may be cured by exposing it to a UV light or electron beam curing system. Accordingly, a sufficient voltage difference across the metal runners 25 and 30 will illuminate all the correctly orientated LEDs 16 since they are all connected in parallel.

In another embodiment, vias leading to the conductor layers 24 and 28 are formed through the substrate 22 along the length of the light strip, and the metal runners 25 and 30 are formed on the back surface of the substrate 22. After the metal ink fills the vias and is cured, the conductive vias electrically connect the metal runners 25 and 30 to the conductor layers 24 and 28, respectively.

The LEDs 16 in each of the eight sections are randomly located but substantially uniformly distributed, so the brightness level of each section is approximately the same. There will typically be hundreds of microscopic LEDs 16 in each of the sections.

If the LED light is to be converted to a different color, such as a white light, a patterned layer of phosphor 34 is printed over each section of LEDs 16. In one example, the LEDs are GaN based and emit blue light. The phosphor 34 comprises a YAG phosphor (emits yellow) and red phosphor. The combination of the blue light leaking through the phosphor 34 and the phosphor light creates white light. Any colors can be created by various combinations of phosphors. Other wavelength-conversion materials may be used instead, such as quantum dots or dyes. The phosphor 34 will appear opaque (e.g., yellow) in its off-state, so FIG. 2 illustrates the light strip prior to the phosphor 34 being deposited.

A protective layer may be deposited over the light strip for increasing light extraction and for protecting the layers. The protective layer may also include optical features such as lenses, diffusers, etc.

In one embodiment, the light emitted from each of the vertically elongated rectangular sections of LEDs has a vertically elongated Lambertian emission profile to better illuminate the bottles along their entire height.

FIG. 3 illustrates the resulting light strip 38 being inserted into a slot or channel formed in an extruded, transparent plastic holder 40. In an actual device, the length of the lamp would be much greater relative to the height, since the length is the width of the shelf and the height is only that needed to provide the required number of LEDs in each section. In an extreme example, the lamp may be 1 inch high and 4 feet long. The light-emitting surface of the holder 40 may include optical elements, such as lenses, to spread light more uniformly across the products to be illuminated. Each of the eight sections of the LEDs (containing a random array of LEDs) is formed to have a narrow rectangular shape so that the light emission profile will be elongated (an oval) rather than circular to more uniformly illuminate a bottle.

The plastic holder 40 has a resilient clip 42 configured for clipping onto the front edge of the wire rack shelf. Different shelves may require different clips.

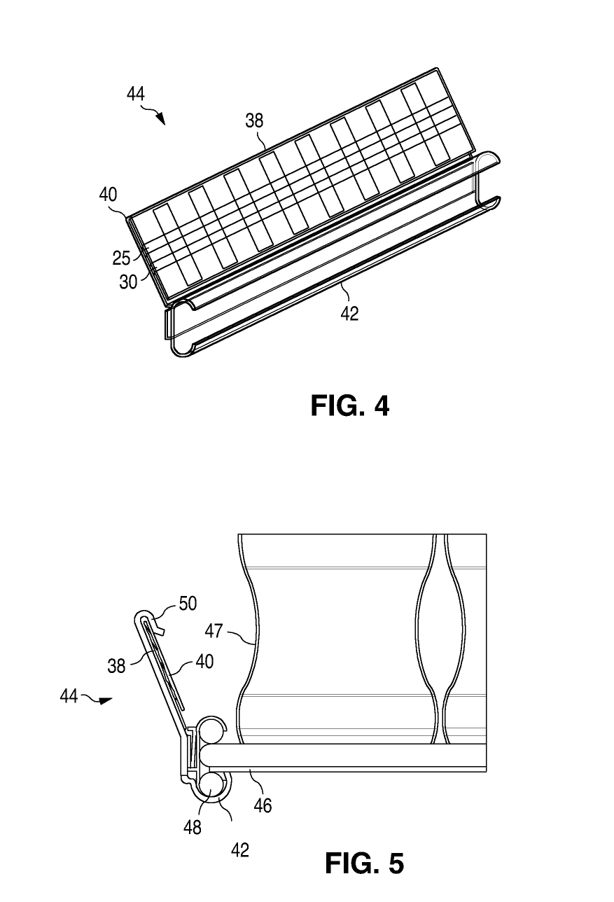

FIG. 4 illustrates the resulting lamp 44.

FIG. 5 is a side view of the clip 42 gripping the front of a shelf 46 supporting bottles 47. The front of the shelf 46 includes two metal rods 48 for mechanical strength. The holder 40 angles the light strip 38 between 20-40 degrees, relative to vertical, to more uniformly illuminate the bottles 47. The optimal angle depends on the distance between product and the light strip 38 and the heights of the products. A 30 degree angle is shown in FIG. 5.

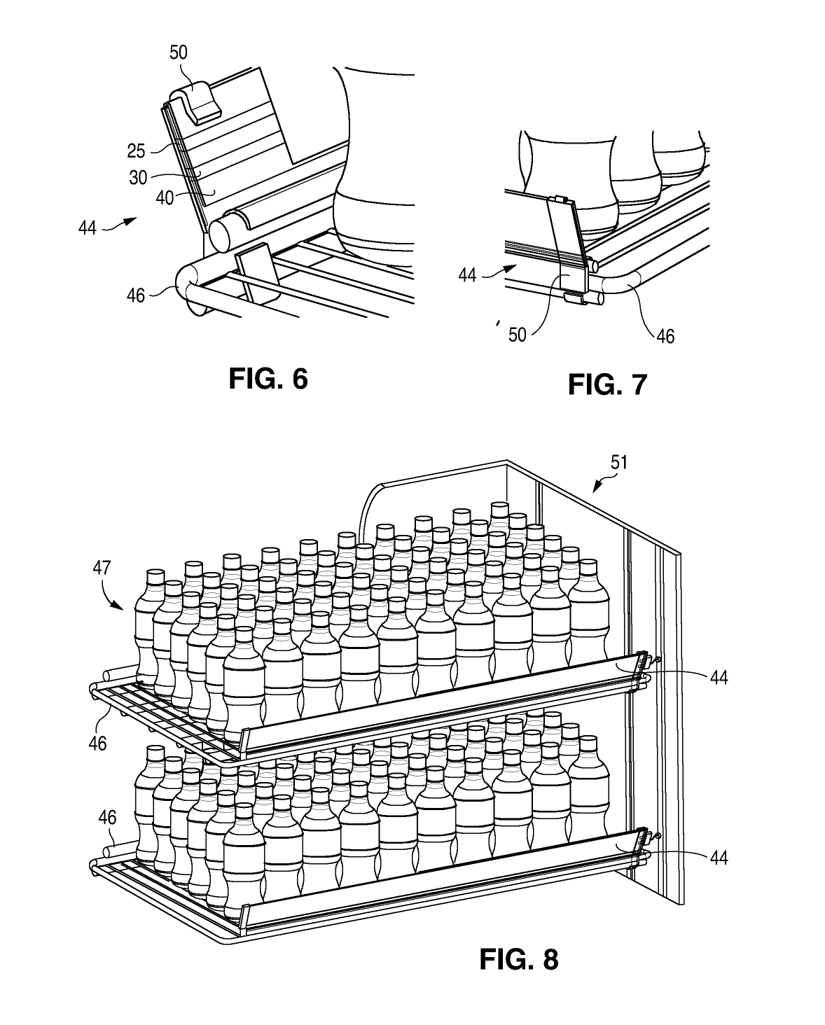

FIGS. 5, 6, and 7 illustrate a plastic end clip 50 that may clip onto the plastic holder 40 to provide additional mechanical support and/or display any information to the consumer. The end clip 50 covers the non-light emitting side of the lamp 44.

FIG. 8 illustrates two lamps 44 secured to the front of the shelves 46, where the lamps 44 are angled upward to optimally illuminate the bottles 47 with a substantially uniform light. Each bottle 47 in the front row of the shelves 46 is positioned directly in front of a single section of the LEDs 16. The shelves 46 are in a glass-door cooler 51, which may have a high of six feet or more and contain at least four shelves 46. Only a portion of the right wall of the cooler 51 is shown. Since there are eight bottles 47 in the front row, the particular light strip used is one that has eight sections of LEDs. If more products in a row were to be illuminated, different light strips would be used that were optimal for that particular display of products.

In more general applications where the glass-door cooler can be used for displaying any product, the light strips 38 may be formed so that the LEDs 16 are uniformly distributed along the length of the strip 38 rather than in sections.

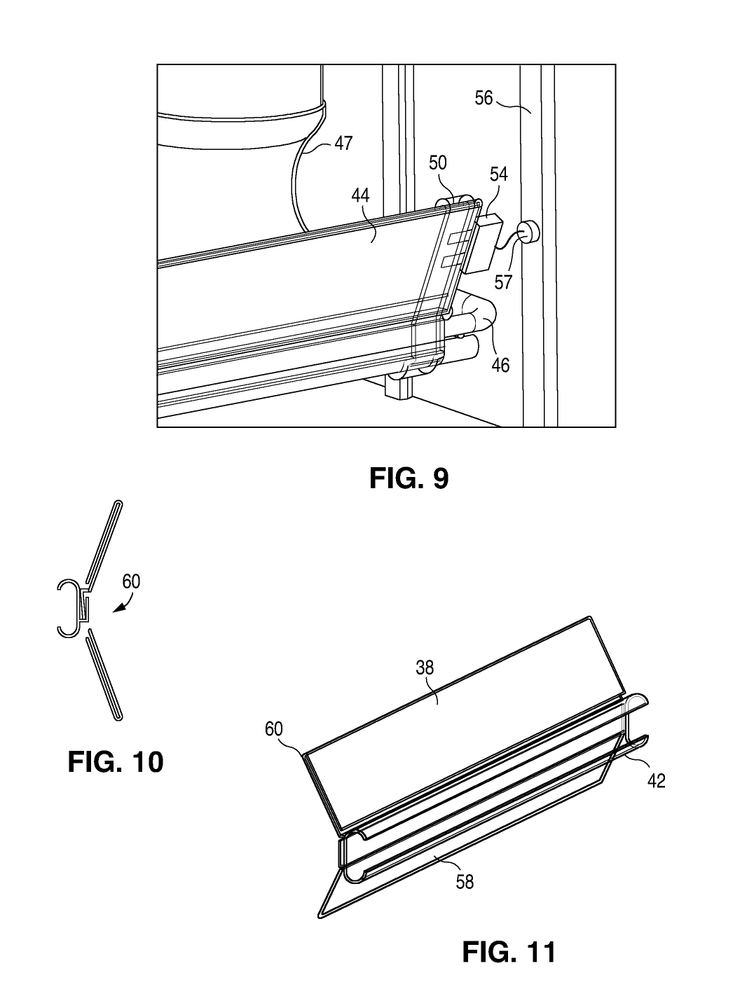

FIG. 9 illustrates how the metal runners 25 and 30 on the light strip 38 may terminate in two metal prongs that are received by a female connector 54. The prongs may be copper and may be soldered to the metal runners 25/30 or affixed to the runners 25/30 by a conductive epoxy. Wires from the connector 54 are connected to a power supply bus 56 along an inner wall of the cooler for illuminating the LEDs 16. The connector 57 for the power supply bus 56 may connect to a vertical track that allows the connector 57 to slide up and down, depending on the position of the shelf, so wires may be short. The end clip 50 may be used to add mechanical strength to the lamp 44 in the area of the prongs.

FIGS. 10 and 11 illustrate another type of lamp where two identical light strips 38 and 58 are inserted into separate channels in a plastic holder 60. After the holder 60 is clipped to the shelf, such as the shelf 46 in FIG. 8, the top light strip 38 is angled to illuminate the bottles 47 on the shelf, while the bottom light strip 58 is angled to illuminate the bottles 47 on the underlying shelf. Each light strip 38/58 may have its own electrical connector 54 (FIG. 9). The same type lamp is clipped to all the shelves except the bottom shelf. This will result in more uniform lighting of the fronts of the bottles 47 in all the shelves. Each light strip 38/58 may include fewer LEDs since the brightness from two light strips combines to illuminate each bottle 47. The bottom shelf will use the lamp 44 containing the single light strip 38.

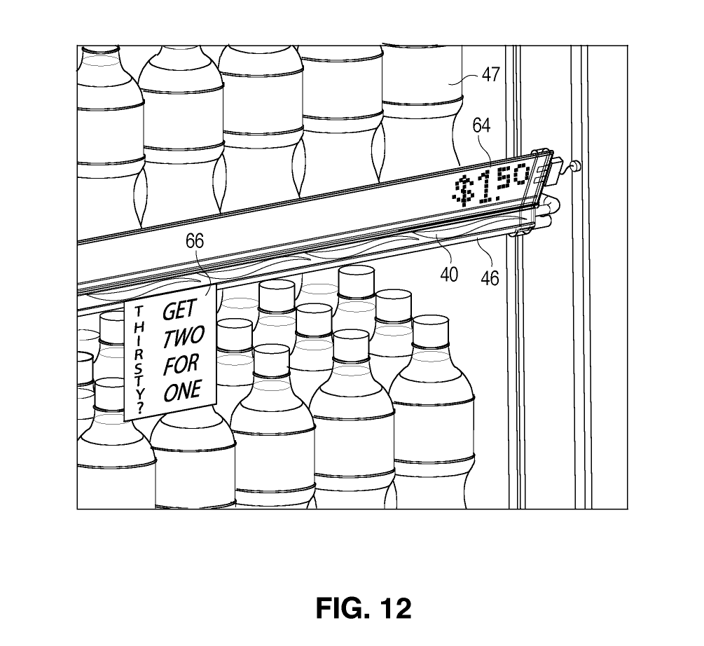

FIG. 12 illustrates that the lamps may include a dot matrix display strip 64 on their back side. Such a display strip 64 may indicate prices or any other information. The display strip 64 may comprise an array of LEDs printed on a separate substrate, or the LEDs may be printed on the back of the substrate 22 (FIG. 1). The LEDs in the display may be separately addressable using X and Y address lines and illuminated by applying signals to a controller mounted on the substrate and connected to the X and Y address lines. Digital control signals may be conducted by the same wires that supply power to the LEDs.

FIG. 12 also illustrates a separate display 66 that also snaps onto the shelf 46. The display 66 may use a printed array of LEDs to serve as a backlight for a translucent sheet that has printed on it any information to convey, such as sales. Upper and lower channels in the display 66 allow the translucent sheet to be slid into place. The translucent sheet may be frequently replaced with other sheets for conveying different information. A power connector is provided on the back of the display 66, or connector wires extend from the display 66. The plastic holder 40 may include a channel for the power supply wires leading to the display 66.

All the embodiments described herein may be formed by printing the various layers in a roll-to-roll process, at atmospheric pressures, where the roll is eventually singulated.

In another embodiment, the light strip may use an array of conventional LEDs, and the LEDs may include lenses for creating a desired emission profile, such as a Lambertian profile. The light strip may be supported by a holder similar to the holder 40 so as to be angled upward to illuminate the fronts of the products on the shelf. The light strip may be rigid or flexible.

Accordingly, a novel shelf lighting system has been described that evenly illuminates products on the shelf of a cooler or other display case, is very efficient due to the lower required brightness level and the close proximity to each product, is very reliable, is easily replaceable for adapting to different products, and is inexpensive to fabricate.

While particular embodiments of the present invention have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. An illumination system for shelved products comprising:
a light strip comprising light emitting diodes (LEDs), the light strip having a light emission side; and
a holder supporting the light strip, the holder including an attachment device configured to be attached to a front of a shelf supporting the products, the holder being configured to position the light emission side of the light strip at an upward angle when the holder is attached to the shelf to illuminate the products supported by the shelf.

2. The system of claim 1 wherein a length of the light strip is approximately as long as the shelf.

3. The system of claim 2 wherein the light strip has a width less than 2 inches.

4. The system of claim 1 wherein the light strip comprises separate arrays of LEDs formed in sections, the sections being linearly aligned along the light strip, wherein each section is positioned so as to be approximately centered with respect to an associated product on the shelf in front of the light strip.

5. The system of claim 1 wherein the light strip comprises microscopic LEDs on a substrate.

6. The system of claim 1 wherein the light strip comprises an electrical connector at one end of the light strip, the system further comprising a power bus along a wall of an enclosure supporting the shelf, the connector being connected to the power bus for illuminating the LEDs.

7. The system of claim 1 wherein the shelf is supported in a glass-door cooler.

8. The system of claim 1 wherein the light strip is flexible and the holder includes a channel that supports the light strip.

9. The system of claim 1 wherein the LEDs in the light strip are arranged in sections across the light strip, with a gap between each section, wherein each of the sections is formed to have a rectangular shape so that the light emission profile of each section will be elongated in a vertical direction to more uniformly illuminate the products on the shelf.

10. The system of claim 9 wherein each section of LEDs comprises an array of LEDs extending between an upper edge of the light strip and a lower edge of the light strip.

11. The system of claim 1 wherein the light strip is a first light strip and wherein the shelf is a first shelf, the system further comprising:
a second light strip comprising LEDs and having a light emission side;
wherein the holder supports the first light strip so that its light emission side is at the upward angle when the holder is attached to the first shelf to illuminate products supported by the first shelf, and wherein the holder supports the second light strip below the first shelf so that its light emission side is at a downward angle when the holder is attached to the first shelf to illuminate products supported by a second shelf below the first shelf.

12. The system of claim 1 further comprising an end clip for the holder that adds mechanical strength to the holder at its end.

13. The system of claim 1 wherein the attachment device comprises a clip configured to clip onto one or more horizontal rods at a front of the shelf.

14. The system of claim 1 further comprising a flat alphanumeric display device opposing a side of the light strip opposite to the light emitting side.

15. The system of claim 14 wherein the display device has a length approximately a length of the light strip.

16. The system of claim 1 further comprising a backlight display attached to the holder for backlighting signs.

17. The system of claim 1 wherein the holder is attached to the front of the shelf supporting the products.

18. A method for illuminating products on a shelf comprising:
providing a light strip comprising light emitting diodes (LEDs), the light strip having a light emission side; and
supporting the light strip in a holder, wherein the holder is attached to a front of the shelf supporting the products, the holder positioning the light emission side of the light strip at an upward angle to illuminate products supported by the shelf; and
supplying power the LEDs to illuminate the products.

19. The method of claim 18 wherein the light strip comprises separate arrays of LEDs formed in sections with a gap between adjacent sections, the sections being linearly aligned along the light strip, wherein each section is positioned so as to be approximately centered with respect to an associated product on the shelf in front of the light strip.

20. The method of claim 19 wherein each of the sections is formed to have a rectangular shape so that the light emission profile of each section will be elongated in a vertical direction to more uniformly illuminate the products on the shelf.
